(19) United States
(12) Patent Application Publication
(10) Pub. No.: US 2010/0003562 A1
(43) Pub. Date: Jan. 7, 2010

(54) FUEL CELL SYSTEM WITH DEVICE FOR CATHODE INLET AIR PREHEATING

(75) Inventors: Stefan Kading, Zerrenthin (DE); Norbert Gunther, Ribnitz-Damgarten (DE); Matthias Muller, Neubrandenburg (DE)

Correspondence Address: FITCH EVEN TABIN & FLANNERY, 120 SOUTH LASALLE STREET, SUITE 1600, CHICAGO, IL, 60603-3406, US

(73) Assignee: Enerday GmbH, Neubrandenburg (DE)

(21) Appl. No.: 12/514,228

(22) PCT Filed: Sep. 17, 2007
(86) PCT No.: PCT/DE2007/001676

§ 371 Date: Jul. 21, 2009

(30) Foreign Application Priority Data
Nov. 13, 2006 (DE) 10 2006 053 429.8

(51) Int. Cl. H01M 8/04

(52) U.S. Cl. 429/22; 429/26

(57) ABSTRACT

The invention relates to a fuel cell system including a first heat exchanger via which cathode feed air can be supplied to a fuel cell or fuel cell stack and to which a mixture of afterburner exhaust gas of an afterburner and cathode exhaust air having materialized in the fuel cell or fuel cell stack can be supplied for heat exchange between the cathode feed air and the mixture via the first heat exchanger. In accordance with the invention it is provided for that a second heat exchanger is provided via which the cathode feed air can be supplied from the first heat exchanger to the fuel cell or fuel cell stack and via which the afterburner exhaust gas can be supplied to the first heat exchanger to form the mixture, in thus achieving a heat exchange between the afterburner exhaust gas and the cathode feed air.

The invention relates to a fuel cell system including a first heat exchanger via which cathode feed air can be supplied to a fuel cell or fuel cell stack and to which a mixture of afterburner exhaust gas of an afterburner and cathode exhaust air having materialized in the fuel cell or fuel cell stack can be supplied for heat exchange between the cathode feed air and the mixture.

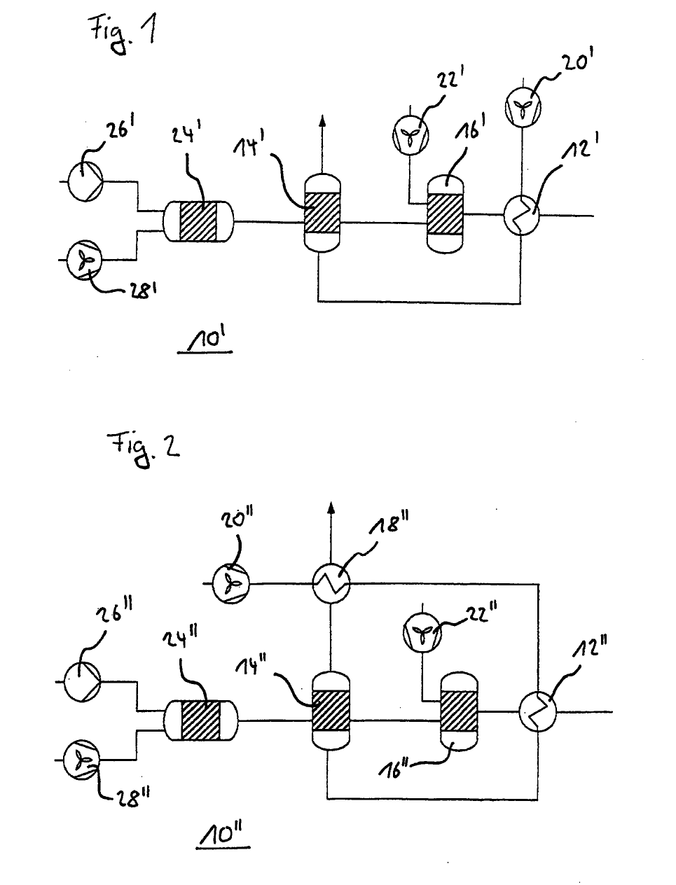

Fuel cell systems with heat exchangers for preheating cathode feed air are known in general from prior art. An example of one such fuel cell system is evident from the diagrammatic representation in FIG. 1. The fuel cell system 10′ comprises a fuel cell stack 14′. The fuel cell stack 14′ is coupled at the anode input side to a reformer 24′ so that the anode side of the fuel cell stack 14′ can receive a supply of hydrogen rich reformate from the reformer 24′. To generate the reformate the reformer 24′ is coupled to a fuel feeder 26′ and an air feeder 28′ via which fuel and air can be fed to the reformer 24′. In addition, the fuel cell stack 14′ is coupled at the cathode input side via a heat exchanger 12′ to a cathode feed air feeder 20′ to supply cathode feed air to the cathode side of the fuel cell stack 14′. To discharge depleted reformate having materialized during operation of the fuel cell stack 14′, the fuel cell stack 14′ is additionally connected at the anode output side to an afterburner 16′ serving particularly the combustion of noxious substances in the depleted reformate. Furthermore, the fuel cell stack 14′ discharges during operation from the cathode output side cathode exhaust air to the environment, for example. In addition to being coupled to the fuel cell stack 14′ the afterburner 16′ is also coupled to an afterburner air feeder 22′ via which the afterburner air needed by the afterburner 16′ for combustion can be supplied. To discharge afterburner exhaust gas having materialized in operation of the afterburner, the afterburner 16′ is coupled furthermore via the heat exchanger 12′ to the environment. The heat exchanger 12′ thus permits heat exchange between the afterburner exhaust gas and the cathode feed air. In operation of the known fuel cell system 10′ the cathode feed air supplied by the cathode feed air feeder 20′ is heated before attaining the fuel cell stack 14′ by the heat exchanger 12′ due to the heat exchange from the hotter afterburner exhaust gas having materialized during combustion in the afterburner 16′. By means of this fuel cell system 10′ the cathode feed air can be heated to a temperature in the range of approximately 600 to 850° C. before attaining the fuel cell stack 14′. However, the structure of this fuel cell system 10′ makes it very difficult to control the cathode feed air, particularly with respect to its temperature. One possibility of controlling the cathode feed air temperature is to vary a lambda value of the afterburner. However, the lambda value is limited by a low calorific value of the depleted reformate when the reactions in the fuel cell and the efficiencies of the fuel cell system are high. In addition to this, a lot of potentially useful energy is lost in discharging the cathode exhaust air of the fuel cell stack 14′ to the environment.

A further prior art fuel cell system 10″ comprising two heat exchangers 12″, 18″ for preheating the cathode feed air is shown in FIG. 2, wherein components of the fuel cell system 10″ corresponding to those shown in FIG. 1 have like reference numerals, this being the reason why these components are not explained, but only the differences as compared to the fuel cell system 10′ as shown in FIG. 1. The fuel cell system 10″ as shown in FIG. 2 differs from the fuel cell system 10′ explained above and as shown in FIG. 1 mainly in that a second heat exchanger 18″ is provided, formed in particular by a recuperator or tubular heat exchanger. The second heat exchanger 18″ is inserted directly downstream of the cathode feed air feeder 20″ and directly upstream of the first heat exchanger 12″. Thus, the cathode feed air delivered by the cathode feed air feeder 20″ first flows through the second heat exchanger 18″ before attaining the first heat exchanger 12″. In addition the second heat exchanger 18″ is coupled at the cathode output side to the fuel cell stack 14″ so that via the second heat exchanger 18″ the cathode exhaust air can be discharged. In this arrangement the second heat exchanger 18″ additionally achieves a heat exchange between the cathode exhaust air discharged from the fuel cell stack 14″ and the cathode feed air delivered by the cathode feed air feeder 20″. Of advantage in the structure of this fuel cell system 10″ is that despite a low energy level in the afterburner exhaust gas and a high cathode feed air requirement of the fuel cell stack 14″ an adequate cathode feed air temperature can be made available by the second heat exchanger 18″. This configuration has nevertheless the drawback that the afterburner exhaust gas cannot be cooled down again to low temperatures, since at least part of the energy of the fuel cell system 10″ remains maintained in the cathode feed air. This results in, for example, that when the cathode feed air temperature is maintained at a level of 500° C., the temperature of the afterburner exhaust gas is also at least in the region of this temperature level.

A further example of a known generic fuel cell system 10′″ is shown by way of example in FIG. 3. In this case, the same as in the example shown in FIG. 1, just a single heat exchanger 12′″ is provided in the same way. However, in the fuel cell system 10′″ as shown in FIG. 3 the cathode exhaust air is admixed with the afterburner exhaust gas so that a mixture of at least afterburner exhaust gas and cathode exhaust air can be fed to the heat exchanger 12′″. Otherwise the fuel cell system 10′″ shown in FIG. 3 corresponds to that shown in FIG. 1. This configuration achieves a more efficient supply of energy contained in the cathode exhaust air or thermal energy contained in the fuel cell system 10′″ compared to the fuel cell system 10″ shown in FIG. 2. The drawback of this fuel cell system 10′″ is, however, that the time needed to heat up the fuel cell system 10′″ can possibly take considerably longer, particularly during the starting phase. The reason for this is that at least when starting the fuel cell system 10′″ the temperature of the cathode feed air streaming through the heat exchanger 12′″ is substantially reduced due to the cold cathode exhaust air admixed at this point in time, resulting in a significant reduction in the temperature of the afterburner exhaust gas, as a result of which the heat exchange in the heat exchanger 12′″ is also diminished.

The invention is thus based on the object of sophisticating the generic fuel cell systems such that more energy can be attained in the fuel cell system for preheating the cathode air without excessively prolonging the time need to heat up the system.

This object is achieved by the features of the independent claim.

Further advantage aspects and further embodiments of the invention read from the dependent claims.

The fuel cell system in accordance with the invention is a sophistication over prior art in that a second heat exchanger is provided via which cathode feed air can be supplied from the first heat exchanger to the fuel cell or fuel cell stack and via which the afterburner exhaust gas can be supplied to the first heat exchanger to form the mixture in thus achieving a heat exchange between the afterburner exhaust gas and the cathode feed air. The cathode exhaust air is admixed with the afterburner exhaust gas between the first and second heat exchanger, resulting in the thermal energy contained in the cathode exhaust air being maintained at least in part in the fuel cell system. In addition, a more efficient preheating of the cathode feed air is possible during the starting phase of the fuel cell system. Thus, a heat exchange already occurs in the second heat exchanger between exclusively the afterburner exhaust gas and the cathode feed air. It is not until the afterburner exhaust gas has streamed through the second heat exchanger that the cathode exhaust air is admixed with the afterburner exhaust gas, so that cooling of the afterburner exhaust gas due to admixture of the cathode exhaust air is no longer a disadvantage to preheating the cathode feed air. This is why even in the starting phase of the fuel cell system the thermal energy—albeit low—of the afterburner exhaust gas is made use of to preheat the cathode feed air. Preferably the first and second heat exchangers are engineered such that the temperature of the afterburner exhaust gas inbetween the heat exchangers roughly corresponds to that of the cathode exhaust air. To practically eliminate loss of thermal energy in the heat exchangers these are preferably engineered so that the cathode feed air, which is colder compared to the afterburner exhaust gas or the mixture, streams through an outer portion of the heat exchanger, whereas the afterburner exhaust gas or the mixture streams through an inner portion of the heat exchangers so that the outer portion surrounds the inner portion at least sectionwise.

The fuel cell system in accordance with the invention can be sophisticated to advantage in that the fuel cell or fuel cell stack can be further on supplied with cathode feed air in bypassing at least one of the heat exchangers in thus enabling the fuel cell stack or fuel cell to receive specifically a supply of cold and/or heat exchanger heated cathode feed air for closed or open loop control of the cathode feed air temperature.

In this context it is particularly of advantage to configure the fuel cell system in accordance with the invention so that closed loop control of a cathode feed air flow to the first heat exchanger and of a cathode feed air flow to the fuel cell or fuel cell stack in bypassing at least one of the heat exchangers is possible via a flow divider valve. By means of the flow divider valve each flow can be set in accordance with the wanted cathode feed air input temperature. The prerequisite for closed loop control of the cathode feed air input temperature by the flow divider valve is further on, among other things, knowledge of the heat or thermal energy inflow into the cathode feed air at the first and second heat exchanger as well as knowledge of the temperature of the cathode feed air supplied.

Furthermore, the fuel cell system in accordance with the invention can be achieved such that a controller is provided for controlling the flow divider valve, by means of which closed loop control of a temperature of the cathode feed air entering the fuel cell or fuel cell stack is provided. The controller establishes preferably the parameters needed for closed loop control of the cathode feed air input temperature made available to the controller, for example by sensors, in implementing the calculations needed for closed loop control on the basis of these parameters.

Preferred embodiments of the invention will now be detailed by way of example with reference to the FIGs. in which:

FIG. 1 is a diagrammatic representation of a known fuel cell system;

FIG. 2 is a diagrammatic representation of another known fuel cell system;

FIG. 3 is a diagrammatic representation of yet another known fuel cell system;

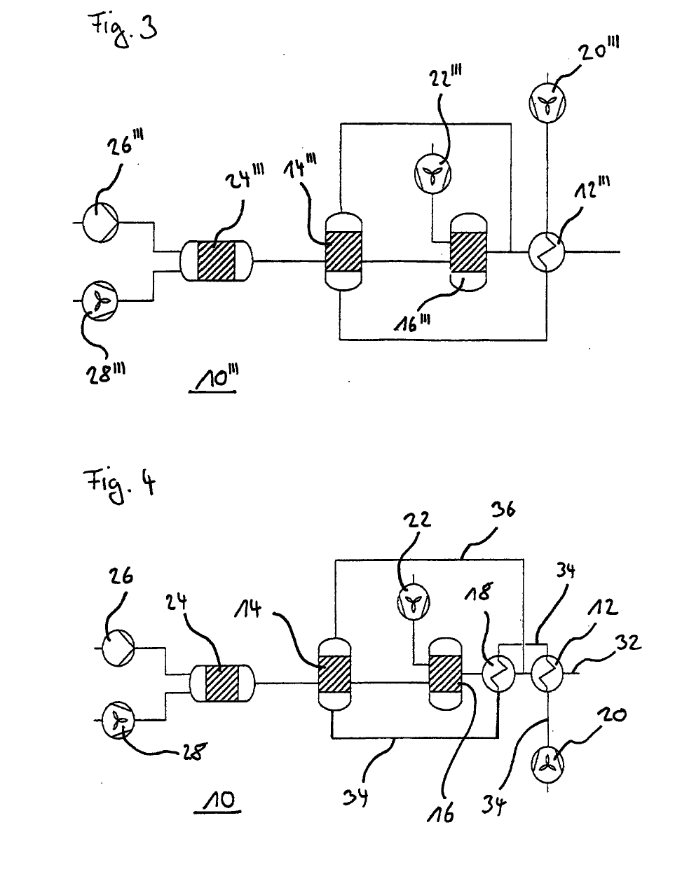

FIG. 4 is a diagrammatic representation of a fuel cell system in accordance with the invention in a first example embodiment of the invention; and

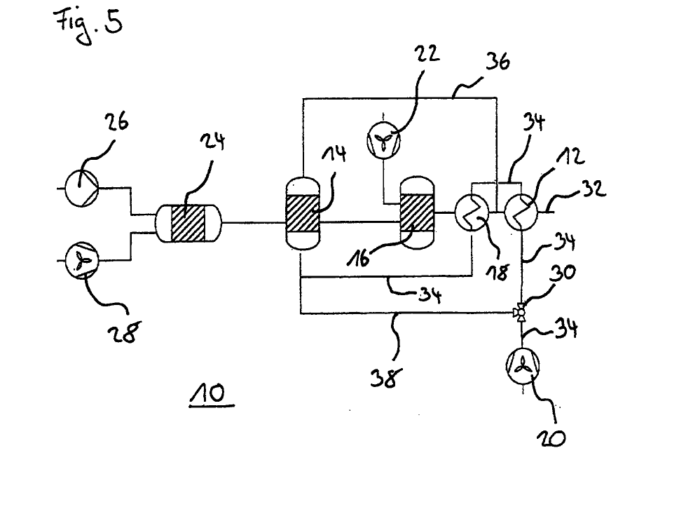

FIG. 5 is a diagrammatic representation of a fuel cell system in accordance with the invention in a second example embodiment of the invention.

Referring now to FIG. 4 there is shown a diagrammatic representation of a fuel cell system 10 in accordance with the invention in a first example embodiment of the invention. The fuel cell system 10 comprises a fuel cell stack 14 with an optional plurality of fuel cells. As an alternative, the fuel cell system 10 may also comprise just a single fuel cell. At the anode input side the fuel cell stack 14 is coupled to a reformer 24 which serves to supply the fuel cell stack 14 with a hydrogen rich reformate at the anode input side. For this purpose, the reformer 24 is coupled at its input side to a fuel feeder 26 and an air feeder 28. Via the fuel feeder 26 and air feeder 28 fuel and air are supplied to the input side of the reformer 24 which form in the reformer 24 a fuel/air mixture and which in operation of the reformer 24 can be reacted into reformate. Furthermore, the fuel cell stack 14 is coupled at the anode output side to an afterburner 16 which, during operation of the fuel cell stack 14, can be fed hydrogen depleted reformate having materialized. The afterburner 16 serves particularly to perform combustion of the depleted reformate as near completely as possible. For this purpose an afterburner air feeder 22 is provided which, like the fuel cell stack 14, is coupled at the input side to the afterburner 16 and serves to supply combustion air to the afterburner 16. The afterburner 16 thus makes it possible to discharge a practically non-noxious afterburner exhaust gas at an output side of the afterburner 16 via an afterburner exhaust gas line 32. The afterburner exhaust gas line 32 coupled at the output side to the afterburner 16 passes through two heat exchangers 18 and 12 as will be detailed later on. The fuel cell stack 14 is, in addition, coupled at the cathode input side via a cathode feed air line 34 to a cathode feed air feeder 20. The cathode feed air line 34, like the afterburner exhaust gas line 32, also passes through the two heat exchangers 18 and 12, whereas it passes firstly through the first heat exchanger 12 and then through the second heat exchanger 18 in the direction towards the fuel cell stack 14. In the case of the afterburner exhaust gas line 32 the sequence is reversed, i.e. the afterburner exhaust gas line 32 firstly passes through the second heat exchanger 18 and then through the first heat exchanger 12 before the afterburner exhaust gas is discharged, for example, to the environment. In addition, the fuel cell stack 14 is coupled at the cathode output side via a cathode exhaust air line 36 to the afterburner exhaust gas line 32, the cathode exhaust air line 36 porting between the first and second heat exchangers 12 and 18 into the afterburner exhaust gas line 32.

The way in which the fuel cell system 10 in accordance with the invention operates will now be detailed by firstly referring to normal operation phase of the fuel cell system 10. In this phase the fuel cell stack 14 and the afterburner 16 can each furnish cathode exhaust air and afterburner exhaust gas at an adequate temperature so that the cathode feed air can be preheated in utilizing the cathode exhaust air and the afterburner exhaust gas, i. e. both the cathode exhaust air and the afterburner exhaust gas contain sufficient thermal energy for preheating the cathode feed air. In the following a starting phase of the fuel cell system 10 in accordance with the invention is detailed. In a starting phase, particularly the cathode exhaust air furnishes extremely little thermal energy and thus features only a very low temperature in thus strongly cooling down the afterburner exhaust gas in admixture with it.

In the normal operation phase of the fuel cell system 10 fuel is fed to the reformer 24 by the fuel feeder 26 and air by the air feeder 28, resulting in a fuel/air mixture in the reformer 24 in which it is reacted into hydrogen rich reformate and subsequently discharged. Ultimately the hydrogen rich reformate gains access to the input side of the fuel cell stack 14, in addition the cathode input side of the fuel cell stack 14 receives a supply of cathode feed air via the cathode feed air line 34 from the cathode feed air feeder 20. This results in the electrochemical reactions generating electricity as known and not detailed in the present. These electrochemical reactions produce at the anode output side of the fuel cell stack 14 depleted reformate which is fed to the afterburner 16 from the fuel cell stack 14. With the supply of afterburner air or combustion air to the afterburner 16 from the afterburner air feeder 22 combustion of the mixture of depleted reformate and combustion air occurs in the afterburner 16, resulting in hot afterburner exhaust gas which is discharged via the afterburner exhaust gas line 32. In this arrangement the hot afterburner exhaust gas streams through the first and second heat exchangers 18 and 12, resulting in heat being exchanged with the usually colder cathode feed air which likewise streams through the first and second heat exchangers 12 and 18 via the cathode feed air line 34. This thus achieves the thermal energy of the afterburner exhaust gas being transferred to the cathode feed air at least in part (depending on a temperature difference, thermal capacities of the media involved, etc.), the cathode feed air then being supplied to the fuel cell stack 14 in thus achieving preheating of the combustion air. In addition, the cathode exhaust air materializing during operation of the fuel cell stack 14 is discharged via the cathode exhaust air line 36 at the cathode output side. In particular, the cathode exhaust air is admixed with the afterburner exhaust gas between the first and second heat exchangers 12 and 18, resulting in the energy contained in the cathode exhaust air during operation of the fuel cell stack 14 additionally being partly held in the fuel cell system 10. It is in this way that the energy and thermal energy contained respectively in the afterburner exhaust gas and cathode exhaust air is transferred at least in part to the cathode feed air in the cathode feed air line 34.

In the starting phase of the fuel cell system 10, respectively during the heating-up phase of the fuel cell system 10, the thermal energy contained in the afterburner exhaust gas is initially low. Likewise is the thermal energy of the cathode exhaust air low in thus, when admixed with the afterburner exhaust gas during the starting phase, resulting in all in cooling of the gas mixture. In the absence of the second heat exchanger 18 (the same as in FIG. 3 of the known fuel cell system 10′″) the cathode exhaust air admixed by the cathode exhaust air line 36 and still cool from the starting phase would mix with the afterburner exhaust gas at a time when the temperature of the mixture would be lower than that of the afterburner exhaust gas. Since the second heat exchanger 18 is provided, at least part of the thermal energy of the even colder afterburner exhaust gas is communicated to the cathode feed air in the cathode feed air line 34. It is not until having streamed through the second heat exchanger 18 that the cathode exhaust air is admixed via the cathode exhaust air line 36 with the afterburner exhaust gas. This already removes thermal energy from the afterburner exhaust gas before a possible cooling by the cathode exhaust air and makes use of it to preheat the cathode feed air.

Referring now to FIG. 5 there is shown a diagrammatic representation of a fuel cell system in accordance with the invention in a second example embodiment of the invention. To avoid tedious repetition in describing the second example embodiment only the differences to the first example embodiment are detailed in the following. The fuel cell system in its second example embodiment differs from that of the first example embodiment in that provided at the cathode feed air line 34 between the cathode feed air feeder 20 and the first heat exchanger 12 is a flow divider valve 30 to directly couple the fuel cell stack 14 via a second cathode feed air line 38 in bypassing the first and second heat exchangers 12 and 18. Setting the flow divider valve 30 permits open or closed loop control of, among other things, the input temperature of the cathode feed air by tweaking the flow of cathode feed air in the cathode feed air line 34 and in the second cathode feed air line 38. The prerequisite for closed loop control can be furthermore, among other things, the knowledge of the thermal energy entering the cathode feed air from the first and second heat exchanger 12 and 18 and knowledge of the temperature of the cathode feed air supplied by the cathode feed air feeder 20. For example, a controller (not shown, but known to the person skilled in the art) may be provided which handles activating the flow divider valve 30 in establishing the corresponding parameters needed for closed loop control of the input temperature of the cathode feed air by way of sensors and/or models and making the calculations needed for closed loop control of the input temperature of the cathode feed air.

As an alternative the second cathode feed air line 38 may be coupled to the cathode feed air line 34 between the first and second heat exchanger 12 and 18 in bypassing the first heat exchanger 12.

It is understood that the features of the invention as disclosed in the above description, in the drawings and as claimed may be essential to achieving the invention both by themselves or in any combination.

### LIST OF REFERENCE NUMERALS

10′ fuel cell system

12′ heat exchanger

14′ fuel cell stack

16′ afterburner

20′ cathode feed air feeder

22′ afterburner air feeder

24′ reformer

26′ fuel feeder

28′ air feeder

10″ fuel cell system

12″ heat exchanger

14″ fuel cell stack

16″ afterburner

18″ second heat exchanger

20″ cathode feed air feeder

22″ afterburner air feeder

24″ reformer

26″ fuel feeder

28″ air feeder

10′″ fuel cell system

12′″ heat exchanger

14′″ fuel cell stack

16′″ afterburner

20′″ cathode feed air feeder

22′″ afterburner air feeder

24′″ reformer

26′″ fuel feeder

28′″ air feeder

10 fuel cell system

12 first heat exchanger

14 fuel cell stack

16 afterburner

18 second heat exchanger

20 cathode feed air feeder

22 afterburner air feeder

24 reformer

26 fuel feeder

28 air feeder

30 flow divider valve

32 afterburner exhaust gas line

34 cathode feed air line

36 cathode exhaust air line

38 second cathode feed air line

1. A fuel cell system including a first heat exchanger via which cathode feed air can be supplied to a fuel cell or fuel cell stack and to which a mixture of afterburner exhaust gas of an afterburner and cathode exhaust air having materialized in the fuel cell or fuel cell stack can be supplied for heat exchange between the cathode feed air and the mixture, characterized in that a second heat exchanger is provided via which cathode feed air can be supplied from the first heat exchanger to the fuel cell or fuel cell stack and via which the afterburner exhaust gas can be supplied to the first heat exchanger to form the mixture, in thus achieving a heat exchange between the afterburner exhaust gas and the cathode feed air.

2. The fuel cell system of claim 1, characterized in that the fuel cell or fuel cell stack can be still supplied with cathode feed air in bypassing at least one of the heat exchangers.

3. The fuel cell system of claim 2, characterized in that closed loop control of a cathode feed air flow to the first heat exchanger and of a cathode feed air flow to the fuel cell or fuel cell stack in bypassing at least one of the heat exchangers is possible via a flow divider valve.

4. The fuel cell system of claim 3, characterized in that a controller is provided for controlling the flow divider valve, by means of which closed loop control of a temperature of the cathode feed air entering the fuel cell or fuel cell stack is provided.
